(19) United States
(12) Patent Application Publication
(10) Pub. No.: US 2009/0195403 A1
(43) Pub. Date: Aug. 6, 2009

(54) OPTICAL WARNING DEVICE

(76) Inventor: Urbain DU PLESSIS, Mentone (AU)

Correspondence Address: STITES & HARBISON PLLC, 1199 NORTH FAIRFAX STREET, SUITE 900, ALEXANDRIA, VA, 22314, US

(21) Appl. No.: 12/362,563

(22) Filed: Jan. 30, 2009

Related U.S. Application Data
(60) Provisional application No. 61/026,569, filed on Feb. 6, 2008.

(30) Foreign Application Priority Data
Jan. 31, 2008 (AU) 2008/900428

(51) Int. Cl. G08B 5/36

(52) U.S. Cl. 340/815.73

(57) ABSTRACT

An optical warning device comprising a light source located within a housing having a wall, a top and a base, the base supporting the light source positioned in front of a reflector to transmit light through a light transmitting surface forming part of the wall of the housing, the top of the housing including an absorber comprising an outwardly facing light shielding surface and an inwardly facing surface profiled to entrap light.

### CROSS REFERENCE TO RELATED APPLICATIONS

This application is based on and claims the benefit of the filing dates of Australian Application No. 2008900428 filed on 31 Jan. 2008 and U.S. Application No. 61/026,569 filed on 6 Feb. 2008, the contents of which are incorporated herein by reference in the entirety.

### INTRODUCTION

This invention relates to optical warning devices for use in a wide range of environments.

### BACKGROUND OF THE INVENTION

Optical warning devices are widely used in road traffic, industrial environments as well as by police and other emergency services to alert people of possible hazards and dangers.

Research has indicated that the speed at which a human being identifies an object in his/her visual field is related to 3 primary criteria namely the luminance or brightness of the object, the size of the object and the contrast between the object and its background. Optical warning beacons exploit luminance and contrast to maximise their visibility and thus speed of recognition. Traffic signals demonstrate this concept by being very bright and also being placed inside a black background shielded from ambient light by a hood. Unfortunately, it is not always practical to place warning signals in the same controlled environment as traffic signals.

It is these issues that have brought about the present invention.

### SUMMARY OF THE INVENTION

According to one aspect of the present invention there is provided an optical warning device that comprises a light source located within a housing, the housing providing optical access to the light source, and an absorber to absorb stray light from external sources.

Preferably, the absorber includes an outwardly facing light shielding surface to shield the device from external light and an inwardly facing light entrapment surface to absorb internally scattered light.

Preferably, the shielding surface is dark, opaque or painted in a dark colour.

According to a further aspect of the invention, there is provided an optical warning device comprising a light source located within a housing having a wall, a top and a base, the base supporting a light source positioned in front of a reflector to transmit light through a light transmitting surface forming part of the wall of the housing, the top of the housing including an absorber comprising an outwardly facing light shielding surface and an inwardly facing surface profiled to entrap light.

### DESCRIPTION OF THE DRAWINGS

Embodiments of the present invention will now be described by way of example only with reference to the accompanying drawings in which:

FIG. 1 is an illustration of a conventional optical warning device showing the effects of sunlight on such a device;

FIG. 2 is a side elevation view of an optical warning device in accordance with the present invention, with a light shield as a separate component;

FIG. 3 is a sectional view of part of the shield forming part of the device of FIG. 2;

FIG. 4 is a cross sectional view of an optical warning device with an integral shield;

FIGS. 5a, b and c are perspective views of shield designs; and

FIGS. 6a and b illustrate forms of the shield as a separate and an integral part of the housing.

### DESCRIPTION OF THE PREFERRED EMBODIMENTS

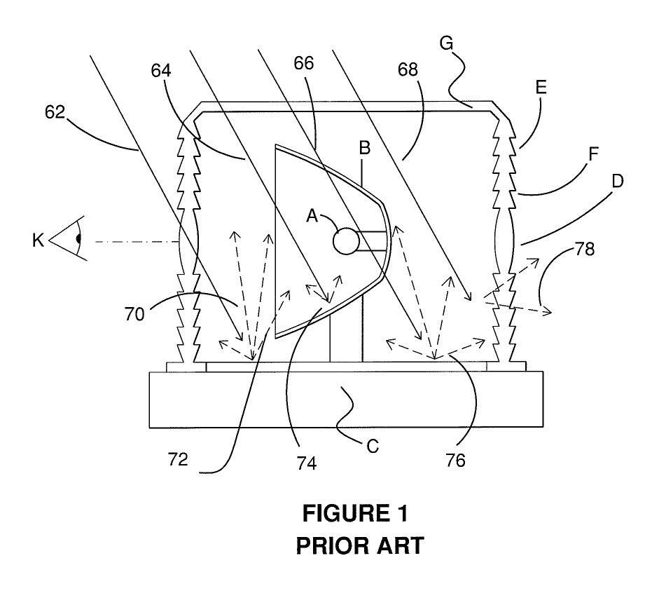

A typical optical warning device is shown in FIG. 1, in which a light source A is positioned centrally of a parabolic reflector B and mounted centrally of a base C. A cylindrical housing D usually made of clear or coloured glass or plastics, sits on top of the light source A. The wall E of the housing may be smooth or contain an annular array of Fresnel reflectors F and the end of the housing defines a top G. The base structure is designed to facilitate mounting the device and may contain control gear and/or motors to, if necessary, rotate the light source and reflector. The light source can be a single lamp or a plurality of LEDs. Although the reflector is shown as parabolic, it is understood that many other shapes of reflector can be incorporated within the device. Alternatively, the reflector may be omitted.

The device shown is designed to produce an optical warning signal visible to observers on the axis K.

FIG. 1 also illustrates the effect of sunlight on an optical warning device. The sunlight can enter the warning device in several distinct ways that are illustrated as follows:
Light 62 can pass through the optics of the wall E and illuminate the base with the light reflecting off the base being scattered through the unit.
Light 64 can enter through the top G and enter the reflector B to be scattered throughout the optical system. This stray light substantially increases the significant chance to create a ghost signal or dilute the effect of the signal produced by the optics.
Light 66 can enter through the top G and illuminate the base with the light reflecting off the base being scattered throughout the unit.
Light 68 can enter through the top G and illuminate the optics 25 in the wall E, again causing scattering light that will create a ghost signal or dilute the effect of the signal produced by the device.

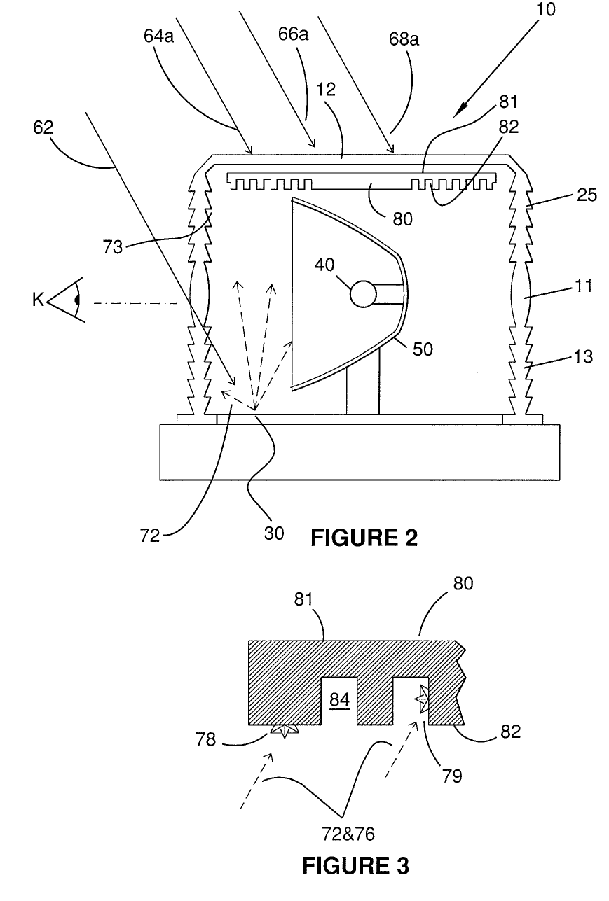

In the optical warning device 10 of the preferred embodiment shown in FIG. 2, the housing 11 is of similar design to the housing D of FIG. 1, that is with a circular top 12 and cylindrical wall 13 which may be either planar or in the form of Fresnel refractors 25. A similar light source 40 with parabolic reflector 50 is mounted centrally of the housing on a base structure 30 in the same manner as FIG. 1. It is understood that the light source and reflector could be rotatable. However, in this embodiment an absorber 80 is positioned on the underside of the top 12 of the housing 11 at a position that it does not impede the exeant beam. The absorber 80 is constructed of light absorbing material such as black thermoplastics and defines an outwardly facing shielding surface 81 and an inwardly facing entrapment surface 82 that is profiled to scatter and capture light.

In this embodiment, when sunlight enters the warning device 10, the detrimental effect is reduced in several ways. Referring to the same sources of light as FIG. 1, light 62 can pass through the optics of the lens 12 and illuminate the base 30. Light 72 reflected off the base 30 is scattered through the unit and light illuminating the surface 82 of the absorber 80 is absorbed before reaching the top 12. The shielding surface 81 blocks light 64a incident on the top 12 at angles that would have entered the optics. The shielding surface 81 blocks light 66a incident on the top 12 at angles that would have illuminated the base. Furthermore, the shielding surface 81 blocks light 68a that could have entered through the top 12 of the device and illuminate the optics 25. The shielding surface 81 blocks much of the incoming light falling on top 12 of the warning device and the entrapment surface 82 also absorbs most of the extraneous light that enters the light from the side and then is scattered throughout the device 10.

The impact of sunlight on the visibility of the signal to an observer on axis K is significant, the effect of uncontrolled light 64, 66, 68 reduces the contrast and may overpower the signal from light source A. The major problem being the magnitude of difference in luminance between light source A and sunlight.

Due to practical limitations and, in particular, the road traffic regulatory requirements it is not possible to increase the intensity of the light signal beyond approximately 2×10³ cd/m².

The luminous intensity of sunlight itself (light rays 60, 62, 64, 68) is generally accepted to be 10⁹ cd/m² under a clear sky.

A practical matte black surface can absorb 90% of incident light; the reflected light of such a surface would thus still have an intensity of approximately 10⁸ cd/m² if reflected into a narrow beam.

The Lambertian nature of light reflected by a matte diffuse surface broadly reduces the observed luminous intensity of an incident light beam by a factor of 4π; which, in combination with the impact of the black surface treatment in this example, still represents a luminous intensity close to 10⁷ cd/m² for an observer from any angle

If FIG. 2 is analysed within the context of the foregoing, it is clear that the reflected light 72 can still be of considerably higher intensity than the signal produced by the light source 40 even if the light source luminous intensity towards observer K is amplified by with the aid of reflector 50.

Under ideal conditions, the upper surface of the base 30 will be a matte black surface and thus be able to attenuate the first reflection of an incoming sunlight ray 62 intensity from 10⁹ cd/m² to 10^{8 cd/m}² through absorption and then to 10⁷ due to Lambertian scattering effect. Should a subsequent cycle of reflections direct the inter reflected sunlight 72 towards the observer K the same combination of absorption and scattering will produce “ghost signals” at a residual luminous intensity of 10⁵ cd/m². Thus after the incident sunlight intensity has been attenuated by 99.99%, the “ghost signal” would still be 100 times stronger than the legal maximum of the signal produced by light source A.

This makes it clear that required light absorption efficiency of the absorber 80 cannot be realized by a simple painted shield or opaque area G of the housing.

As shown in FIG. 3, the entrapment surface 82 of the absorber 80 absorbs light 72, 76 reflected off the internal surface of the device. By way of a matte surface, the light 78 becomes scattered and not focused reducing its observed intensity by 4 [symbol] . As discussed above, the dark colour/surface of the absorber 80 ensures that 80-90% of the light is absorbed. To further improve the absorption efficiency, the internal face 82 defines a geometry designed to entrap light, and specifically avoid directing light towards observers of the warning beacon on axis K (in FIGS. 2 and 3). The surface 82 of the absorber 80 facing the base of the device 10 consists of a multitude of suitably proportioned cavities 84 which trap most of the reflected light 79 through multiple additional reflections each cycle of which absorbs 80-90% of the light. Preferably, the surface of the cavity 84 will be a matte surface finish to produce diffuse reflections

In this manner of capturing the stray light into a multitude of inter-reflection cycles, the resultant observed intensity is substantially reduced below the signal intensity. The visual effect being that the warning device provides a crisp highly illuminated signal with the required contrast to make it readily visible to the human eye in day light conditions without having to resort to increasing the warning signal intensity. Because the absorber 80 is located outside the beam produced by light source 40 and reflector 50 it has no detrimental effect on night time signal visibility.

Three key aspects are required for the light entrapment surface 82 to function as effective light absorber:
A. The roof of the cavity 84 must not visible from observer axis K (FIG. 2);
B. A minimum of the inner wall surface of the cavity 84 is visible from observer axis K;
C. The remaining surface 82 should produce a diffuse reflection.

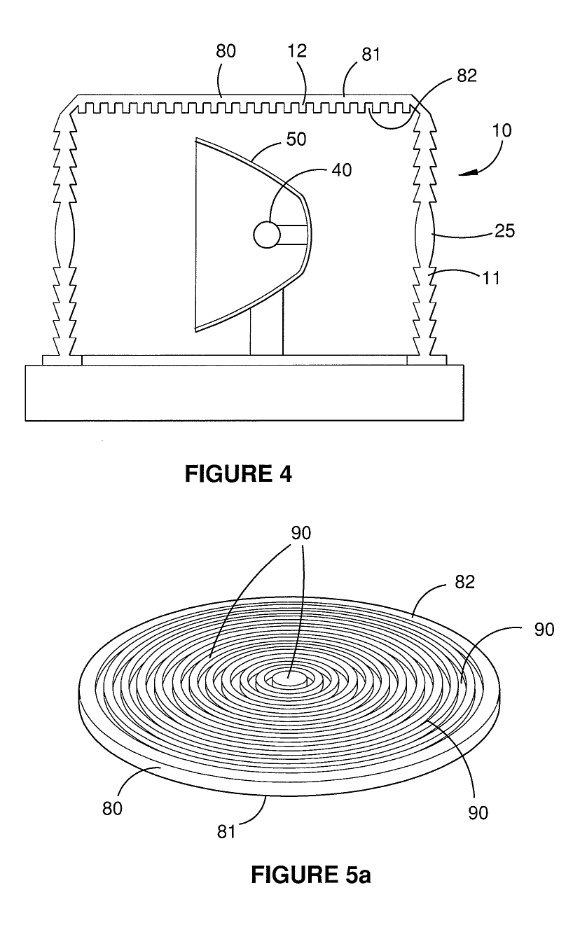

FIG. 4 shows how the absorber 80 can be incorporated into the housing 11. The outer surface 81 of the top 12 of the housing 11 can be fabricated from a dark opaque material or painted a solid dark colour to shield and absorb light. The light entrapment surface 82 can be moulded or machined directly into the housing 11. The substantially vertical sides 25 of the device remains transparent.

It would normally be required to adjust the size and shape of the housing 11 to optimize the function of the integral absorber 80—it being better to bring the absorber in close proximity to the light source and reflector.

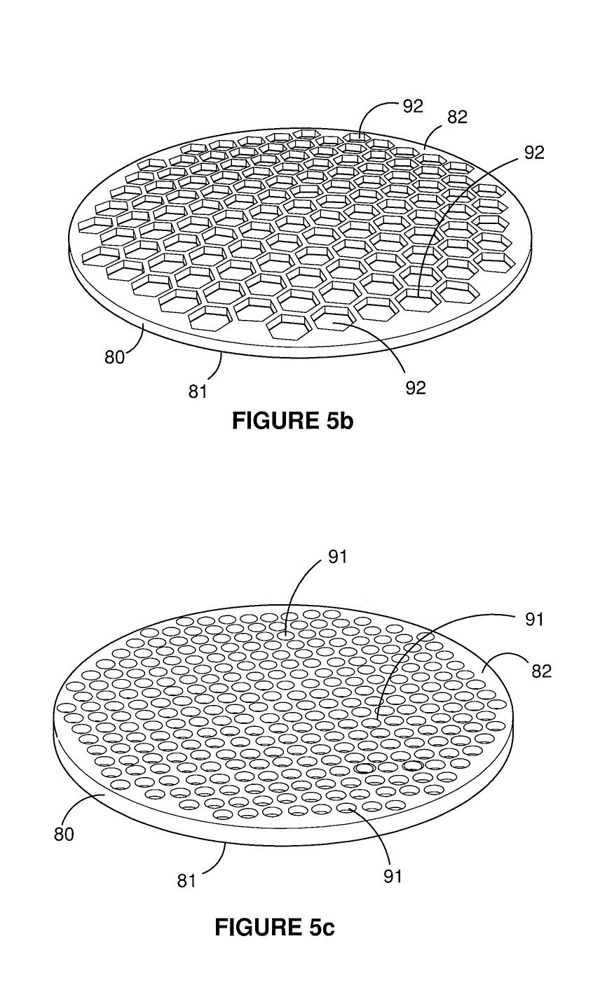

FIGS. 5a, b and c show some of the multitude of possibilities that a skilled practitioner may use to create the light entrapment cavities in the absorber 80, the cavities may be produced as concentric rings 90 (FIG. 5a), round 91 or hexagonal pits 92 (FIGS. 5c and b) and many other shapes, or mixtures of shapes to suit. The Figures show the devices in an inverted position for clarity.

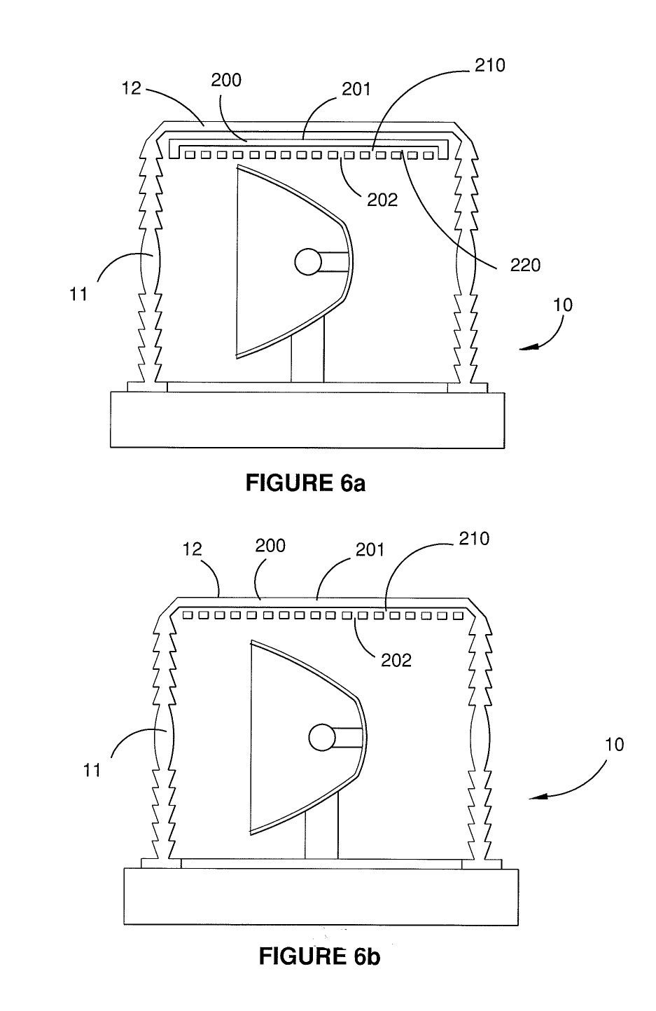

FIGS. 6a and b show the section of another possible design approach for the absorber. The absorber in FIG. 6a comprises a dark coloured hollow device 200 that is a separate item that sits under the top 12 of the housing 11. The outer surface 201 defines the shielding surface whilst holes 202 cause light entering through the holes 202 to be entrapped in the single cavity 210. In FIG. 6b, a similar absorber 200 is integral with the top 12 of the housing 11.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The claims defining the invention are as follows:

1. An optical warning device comprising a light source located within a housing, the housing providing optical access to the light source, and an absorber to absorb stray light from external sources.

2. The optical warning device according to claim 1 wherein the absorber includes an outwardly facing light shielding surface to shield the device from external light and an inwardly facing light entrapment surface to absorb internally scattered light.

3. The optical warning device according to claim 2 wherein the shielding surface is dark, opaque or painted in a dark colour.

4. The optical warning device according to claim 2 wherein the light entrapment means includes a surface profiled to entrap light.

5. The optical warning device according to claim 4 wherein the surface has cavities to trap light.

6. The optical warning device according to claim 5 wherein the cavities define a matte finish in a dark colour.

7. The optical warning device according to claim 5 wherein the cavities are defined by annular grooves in the entrapment surface.

8. The optical warning device according to claim 5 wherein the cavities are defined by a plurality of holes in the entrapment surface.

9. The optical warning device according to claim 8 wherein the holes are circular or hexagonal.

10. The optical warning device according to claim 5 wherein each cavity has a wall and a base whereby the light reflects off the wall and the base to be entrapped within the cavity.

11. The optical warning device according to claim 1 wherein the housing has a wall, a top and a base, with the wall providing optical access to the light source and including the light transmitting surface and the absorber is located under the top of the housing or is integrally formed in the top of the housing.

12. The optical warning device according to claim 4 wherein the surface has a plurality of apertures communicating with a single light absorbing cavity under the surface.

13. An optical warning device comprising a light source located within a housing having a wall, a top and a base, the base supporting the light source positioned in front of a reflector to transmit light through a light transmitting surface forming part of the wall of the housing, the top of the housing including an absorber comprising an outwardly facing light shielding surface and an inwardly facing surface profiled to entrap light.
